(19) United States
(12) Patent Application Publication
(10) Pub. No.: US 2026/0314588 A1
(43) Pub. Date: Oct. 15, 2026

(54) Floating Shoulder Loop for Decoy Anchor Rigs

(71) Applicant: Good Sportsman Marketing, LLC, Irving, TX (US)

(72) Inventors: Fred L. Zink, JR., Port Clinton, OH (US); Damon L. Coalson, Dallas, TX (US)

(21) Appl. No.: 19/640,299

(22) Filed: Apr. 6, 2026

Related U.S. Application Data
(60) Provisional application No. 63/786,137, filed on Apr. 9, 2025.

(51) Int. Cl. A01M 31/06; A45F 3/14

(52) U.S. Cl. CPC A01M 31/06; A45F 3/14; A45F 2003/142

(57) ABSTRACT

Decoys have anchor rigs with lines and fasteners. The lines have a looped end and a weighted end, and the fasteners are slidably disposed on the lines and are connected to the decoys. To handle and organize the decoys and the rigs, a hunter uses a loop having an outer edge and defining an interior space. The loop defines a channel about the outer edge. A connector, such as an eyelet, a hook, or a shackle, at the channel's start can be used to connect to the lines at the looped ends. Lengths of the lines are positioned in the channel, and a retainer, such as a latch, at the channel's outlet can releasably retain the lines passing from the channel. To carry the decoy and anchor rigs, the loop can be positioned on the hunter's shoulder with the hunter's arm extending through the loop's interior space.

### CROSS-REFERENCE TO RELATED APPLICATIONS

This application claims the benefit of U.S. Provisional Appl. No. 63/786,137 filed Apr. 9, 2025, which is incorporated herein by reference in its entirety.

### BACKGROUND OF THE DISCLOSURE

Decoys for waterfowl can be used to create the illusion of a safe, attractive gathering spot where the waterfowl can land, feed, or rest. For example, ducks are social birds and tend to flock toward other ducks when migrating or looking for safe places to land. When ducks see what looks like a group already on the water, the ducks are more likely to come in range of the hunters, believing it is a safe and active spot.

The use of decoys for waterfowl, such as ducks, is thousands of years old and is one of the oldest hunting tools in North America. Earliest decoys dating back over 2,000 years were made by Native American tribes (like the Paiute) and have been found in caves around present-day Nevada. These decoys used bulrushes and feathers. In the 1800s and early 1900s, hunters made hand-carved, hand-painted wooden decoys, and decoy carving became an American folk art.

Modern decoys today are often made of plastic, foam, or lightweight materials, with detailed paint jobs and sometimes built-in movement features. Traditionally, decoys are buoyant devices that merely float on the water surface and may be anchored in place using anchor rigs. For example, FIG. 1A illustrates an arrangement of anchor rigs 10 and decoys 30 according to the prior art, and FIG. 1B illustrates details of a prior art anchor rig 10.

In use, the decoys 30 are arranged in a spread to float on the water, and the anchor rigs 10 anchor the decoys 30. The anchor rig 10 includes an anchor line 20 having a looped end 22 and a weighted end 26, which can have a weight. Fasteners 28, such as swivel clips or clasps, are slidably disposed on the anchor lines 20 and connect to the decoys 30. The anchor line 20 is typically monofilament line. The weighted ends 26 can use slip sinker anchors or the like.

Hunters strategically place the spread of multiple decoys 30 on the water in a realistic pattern that mimics the behavior of live ducks. Hunters use patterns, numbers, and positioning in the spread based on duck behavior, weather, and location. The decoys 30 can be stationary or motion-based (like spinning wing decoys) to add movement and make the setup more convincing.

Hunters may use species-specific decoys 30 (mallards, pintails, teal) to match local flocks. Early in the season, hunters may use smaller spreads of decoys 30 but may use much larger spreads of decoys 30 later in the season when ducks are flocking heavily. Different spread patterns can be used. In J-Hook or Fishhook patterns, for example, ducks tend to land at the open end of the hook. In U-Shape or Horseshoe patterns, ducks naturally land in the opening. Ducks prefer to land into the wind so hunters will often leave an open pocket upwind, steering the ducks toward that area. Additionally, the decoys are usually spaced with enough room between them to look realistic.

When handling the anchor rigs 10 and decoys 30 to set up or take down the spread, a hunter can attach a D-ring or carabiner 24 to the looped ends 22 of a set of the anchor lines 20, such as for a group of 12 or more decoys 30. For example, FIG. 1C illustrates hunters handling the prior art anchor rigs 10 and decoys 30. As shown, a carabiner 24 is connected to the looped ends 22 of sets of the anchor lines 20 for a group of decoys 30 so the hunter can handle the set of anchor lines 20 and decoys 30 altogether. Currently, handling the decoys 30 and anchor rigs 10 can be cumbersome, and the anchor rigs 10 can easily become tangled.

The subject matter of the present disclosure is directed to overcoming, or at least reducing the effects of, one or more of the problems set forth above.

### SUMMARY OF THE DISCLOSURE

A device according to the present disclosure is useable by a person to handle decoys connectable to anchor rigs. The anchor rigs have anchor lines and fasteners. The fasteners are disposed on the anchor lines and are connectable to the decoys. Each of the anchor lines has first and second ends. For example, the first end can be a looped end, and the second end can be a weighted end. The fasteners can be swivel clips or clasps slidably disposed on the anchor lines, and a carabiner can be connectable to the looped ends of the anchor lines.

The device comprises a loop, a connector, and a retainer. The loop has an outer edge and defines an interior space. The loop defines a channel about the outer edge. The channel is configured to hold a length of the anchor lines wound about the outer edge of the loop. The connector is disposed at a first portion of the channel and is configured to hold the first ends of the anchor lines to the loop, such as by connecting directly to (e.g., hooking or shackling to) the looped ends of the anchor lines or by connecting to a carabiner disposed on the looped ends of the anchor lines. The retainer is disposed at a second portion of the channel and is configured to releasably retain the anchor lines with the second (weighted) end passing from the channel.

A device disclosed herein is useable by a person to handle decoys connectable to an anchor system. The anchor system has anchor lines and fasteners. The fasteners are disposed on the anchor lines and are connectable to the decoys. Each of the anchor lines has first and second ends. For example, the first end can be a looped end, and the second end can be a weighted end. The fasteners can be swivel clips or clasps slidably disposed on the anchor lines, and a carabiner can be connectable to the looped ends of the anchor lines.

The device comprises a loop, a connector, and a retainer. The loop has an outer edge and defines an interior space. The loop defines a channel about the outer edge. The channel is configured to hold a length of the anchor lines wound about the outer edge of the loop. The connector is disposed at a first portion of the channel and is configured to hold the first ends of the anchor lines to the loop, such as by connecting directly to (e.g., hooking or shackling to) the looped ends of the anchor lines or by connecting to a carabiner disposed on the looped ends of the anchor lines. The retainer is disposed at a second portion of the channel and being configured to releasably retain the anchor lines with the second (weighted) ends passing from the channel.

An assembly disclosed herein is useable by a person to handle decoys. The assembly comprises an anchor system, a loop, a connector, and a retainer. The anchor system has anchor lines and fasteners. Each of the anchor lines has a looped end and a weighted end. The fasteners, such as swivel clips or clasps, are slidably disposed on the anchor lines and are configured to connect to the decoys.

The loop has an outer edge and defines an interior space. The loop is configured to position on a shoulder of the person with an arm of the person extending through the interior space of the loop. The loop defines a channel about the outer edge. The channel is configured to hold a length of the anchor lines wound about the outer edge of the loop. The connector is disposed at a first portion of the channel and is configured to connect to the looped ends of the anchor lines, such as by connecting directly to (e.g., hooking or shackling to) the looped ends of the anchor lines or by connecting to a carabiner disposed on the looped ends of the anchor lines. The retainer is disposed at a second portion of the channel and is configured to releasably retain the anchor lines with the weighted ends passing from the channel.

The device can further comprise a flotation buoy disposed on the loop. The retainer can comprise a latch hingedly connected to the loop and being movable between a first position and a second position. The latch in the first position can retain the anchor lines in the channel, and the latch in the second position can release the anchor lines from the channel. A spring can bias the latch to the first position.

The loop can comprise a plurality of clips disposed in the channel. The clips can be configured to flexibly receive and release the anchor lines. The loop can have an inner edge disposed about the interior space, and the loop can comprise a padding disposed on a portion of the inner edge facing the interior space.

The loop can have a tear drop shape with a curved top and a pointed bottom. The first and second portions of the channel are disposed at the pointed bottom of the tear drop shape. The connector can comprise an eyelet being configured to connect to a carabiner on the first (looped) ends of the anchor lines. Alternatively, the connector can comprise a hook being configured to hook to the first (looped) ends of the anchor lines. In another alternative, the connector can comprise a shackle being configured to releasably connect to the first (looped) ends of the anchor lines.

The foregoing summary is not intended to summarize each potential embodiment or every aspect of the present disclosure.

### BRIEF DESCRIPTION OF DRAWINGS

FIG. 1A illustrates a decoy anchor rig according to the prior art.

FIG. 1B illustrates anchor lines of the prior art decoy anchor rig.

FIG. 1C illustrates a hunter handling decoy anchor rigs of the prior art.

FIG. 2 illustrates a hunter handling decoy anchor rigs using handling devices of the present disclosure.

FIG. 3 illustrates a handling device of the present disclosure organizing the anchor lines for a decoy anchor rig.

FIG. 4A illustrates an elevational view of the disclosed handling device.

FIG. 4B illustrates a first side view of the disclosed handling device.

FIG. 4C illustrates a second side view of the disclosed handling device.

FIG. 5A illustrates the elevational view of the disclosed handling device in cross-section.

FIG. 5B illustrates a detail of the end of the disclosed handling device in cross-section.

FIG. 6A illustrates another elevational view of the disclosed handling device.

FIG. 6B illustrates another side view of the disclosed handling device.

FIG. 7A illustrates a detail of a flexible clip on the disclosed handling device.

FIG. 7B illustrates a detail of a connector and a retainer on the end of the disclosed handling device.

FIG. 7C illustrates a detail of another connector for the disclosed handling device.

FIG. 7D illustrates a detail of yet another connector for the disclosed handling device.

FIG. 8A illustrates yet another elevational view of the disclosed handling device.

FIG. 8B illustrates another side view of the disclosed handling device.

FIG. 8C illustrates another detail of a connector and a retainer on the end of the disclosed handling device.

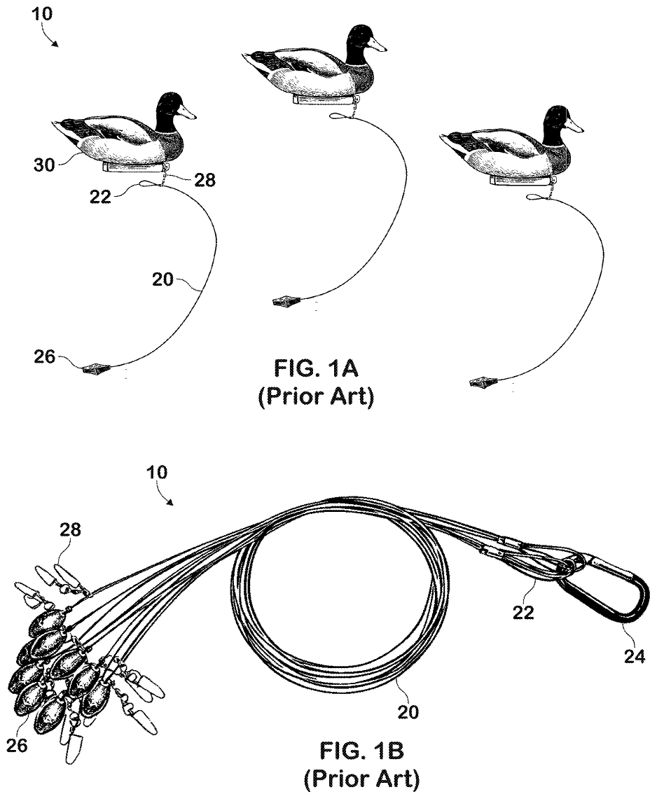

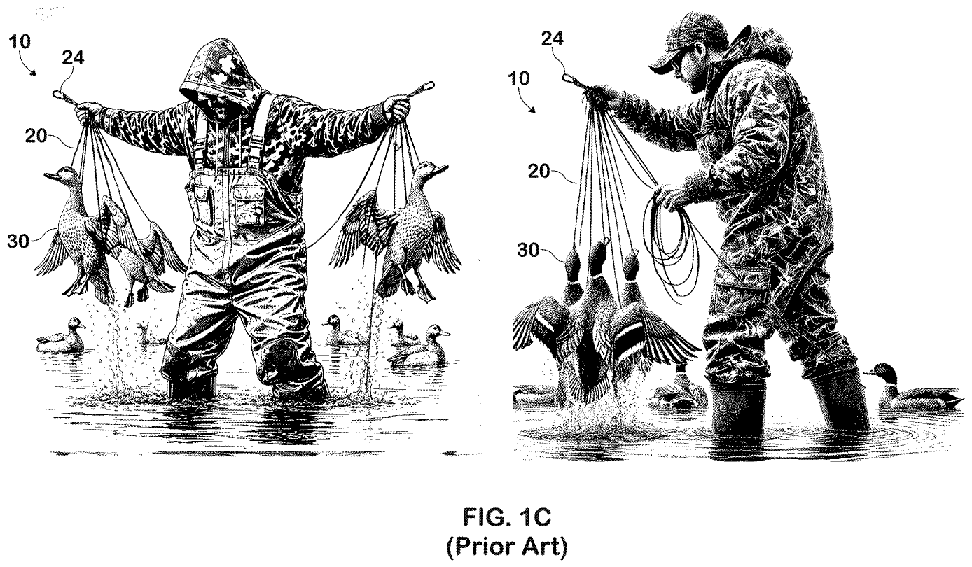

### DETAILED DESCRIPTION OF THE DISCLOSURE

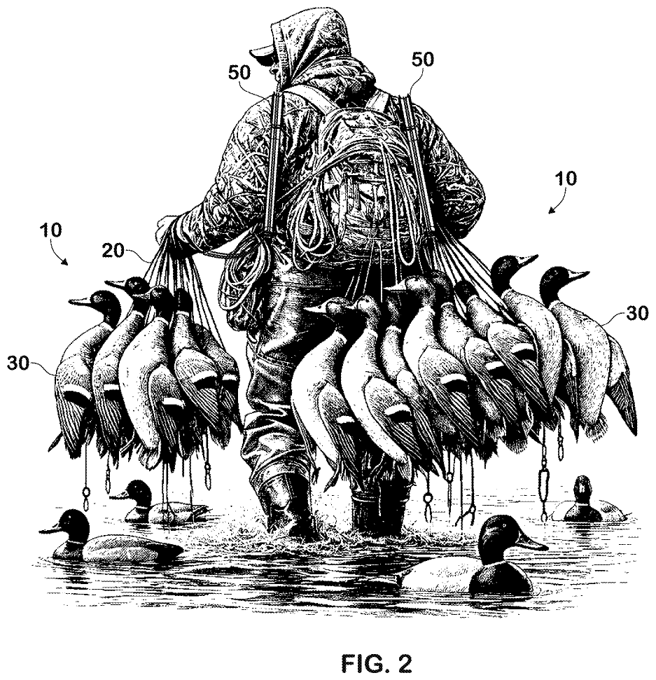

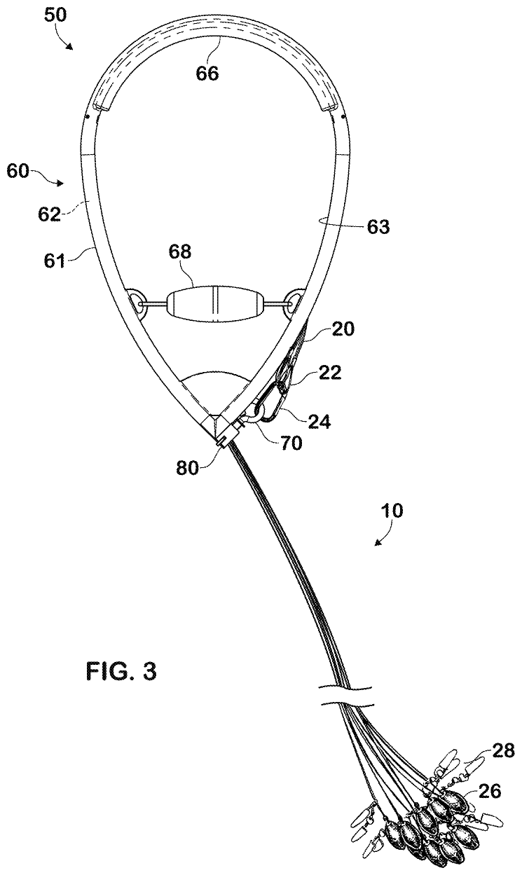

FIG. 2 illustrates a hunter handling multiple anchor rigs 10 having decoys 30 and anchor lines 20 using handling devices 50 of the present disclosure, and FIG. 3 illustrates a handling device 50 of the present disclosure for organizing anchor lines 20 of anchor rigs 10 for a spread of decoys (not shown). As noted above, the anchor lines 20 are part of an anchor rig 10, which uses fasteners 28 (e.g., swivel clips or clasps) and a D-ring or carabiner 24. Each of the anchor lines 20 has a looped end 22 and a weighted end 26, which can include a weight. The carabiner 24 is connected to the looped ends 22 of the anchor lines 20, and the fasteners 28 are slidably disposed on the anchor lines 20 and connect to the decoys 30.

As shown in FIG. 3, the handling device 50 includes a loop 60 having an outer edge 61 and defining an interior space 63. As shown in FIG. 2, the loop 60 is configured to position on the shoulder of a hunter so the hunter's arm extends through the interior of the loop. The loop helps the hunter organize and carry sets of decoys and anchor lines together.

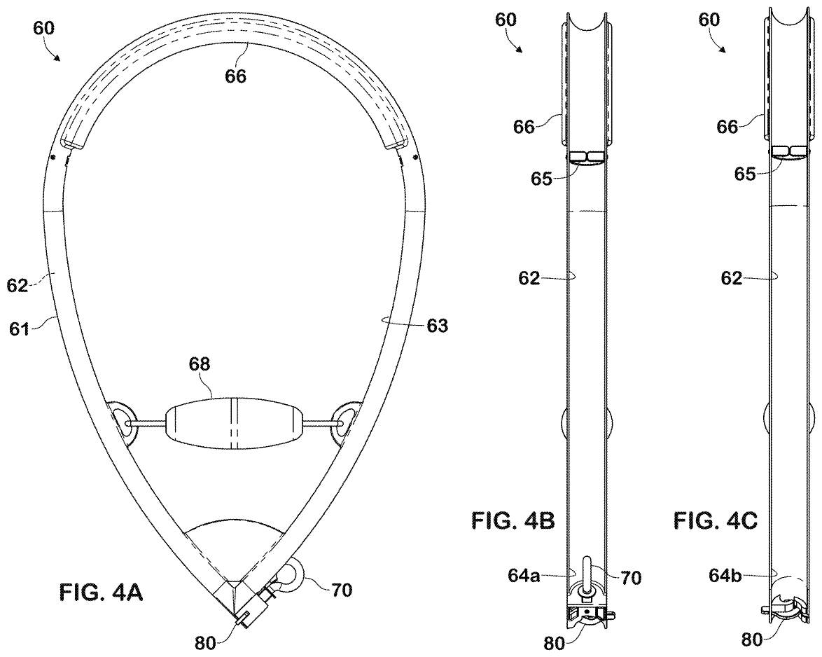

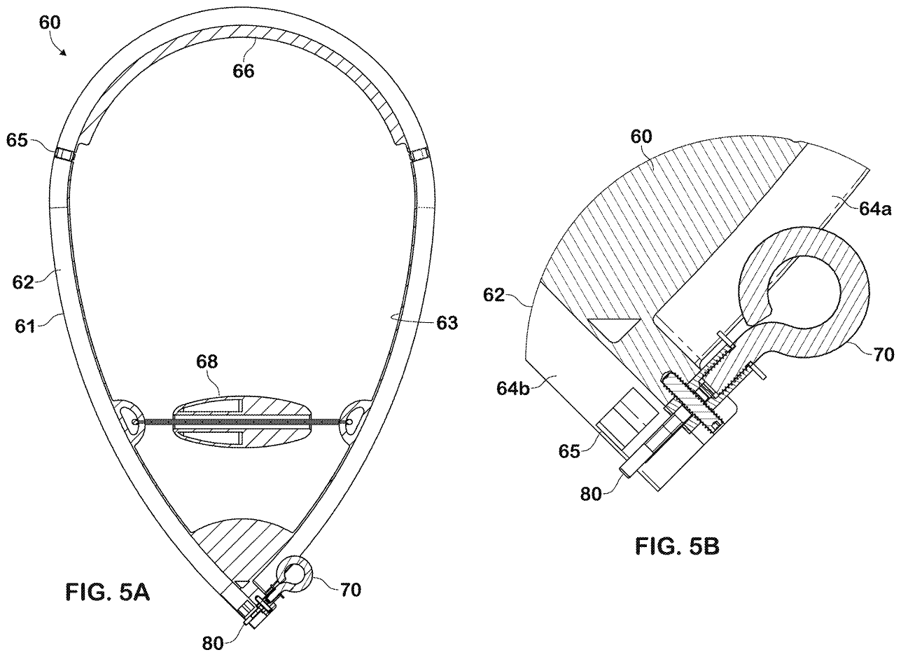

In addition to FIG. 3, further details of the loop 60 for handling device 50 are shown in FIGS. 4A-4C and 5A-5B. In particular, FIG. 4A illustrates an elevational view of the disclosed loop 60, FIG. 4B illustrates a first side view of the disclosed loop 60, and FIG. 4C illustrates a second side view of the disclosed loop 60. Additionally, FIG. 5A illustrates the elevational view of the disclosed loop 60 in cross-section, and FIG. 5B illustrates a detail of the end of the disclosed loop 60 in cross-section.

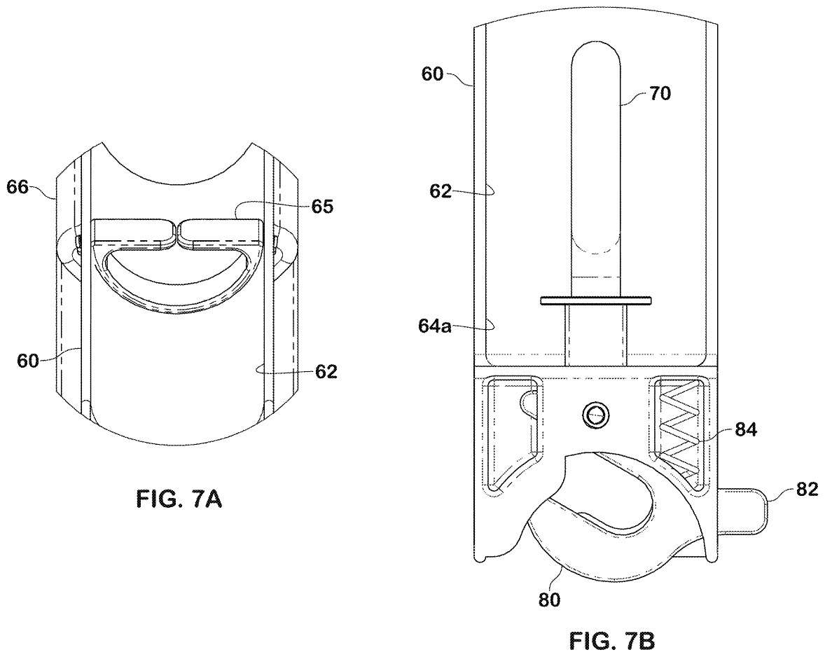

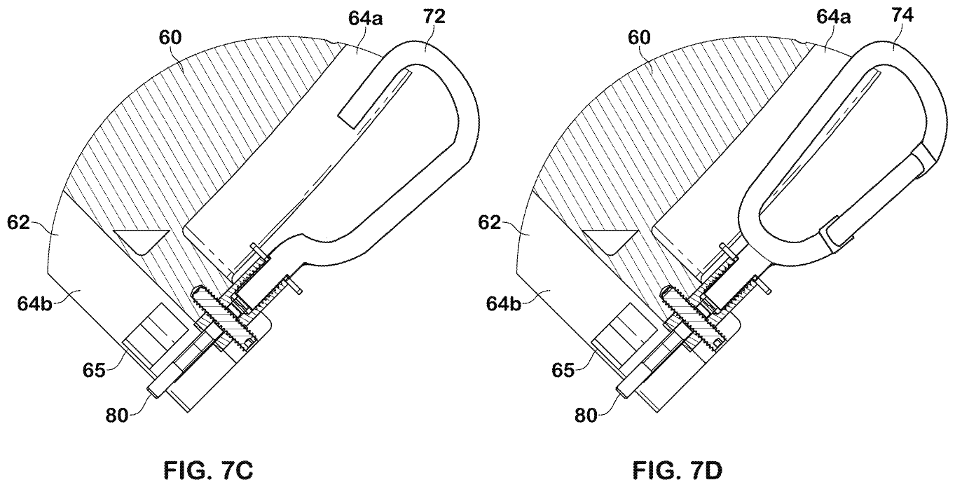

The loop 60 has an outer edge 61 and defines an interior space 63. As shown, the loop 60 can have a tear drop shape with a curved top and a pointed bottom. The outer edge 61 of the loop 60 defines a channel 62 in which a length of the anchor lines 20 can be wrapped. A plurality of clips 65 can be disposed in the channel 62. (FIG. 7A shows an isolated view of one of the clips 65 in the channel 62 of the loop 60.) These clips 65 can flexibly receive and release the anchor lines 20 when wound/unwound in the channel 62 about the outer edge of the loop 60.

As shown in FIGS. 4A and 5A, a flotation buoy 68 can be disposed on the loop 60, such as in the interior space 63 of the loop 60. The flotation buoy 68 will float at the water surface should the handling device 50 be temporarily placed in the water or inadvertently dropped. A padding 66 can be disposed on the loop 60 at the interior to fit against the shoulder of the hunter when worn. The padding 66 may also offer flotation.

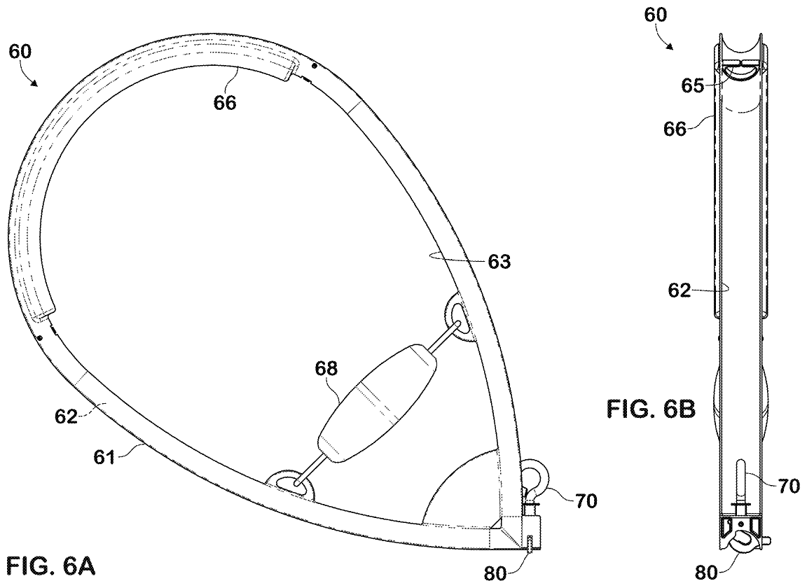

The channel 62 has a first end or start 64a having a connector 70, and the channel 62 has a second end or outlet 64b having a retainer 80. FIG. 6A illustrates another elevational view of the disclosed loop 60, and FIG. 6B illustrates another side view of the disclosed loop 60. Additionally, FIG. 7B illustrates a detail of the connector 70 and the retainer 80 on the pointed end of the loop 60.

In the current arrangement, the connector 70 is an eyelet, which is best shown in FIGS. 5B, 6B and 7B. The eyelet 70 is disposed at the start 64a of the channel 62, being threaded into the pointed end of the loop 60 at the start 64a of the channel 62. The eyelet 70 is configured to connect to the carabiner 24 as shown in FIG. 3 on the looped ends 22 of the anchor lines 20 so the anchor lines 20 can start their winding in the channel 62 about the outer edge 61 of the loop 60.

For its part, the retainer 80 is configured to releasably retain the anchor lines 20 passing from the second end or outlet 64b of the channel 62. Various forms of retainer 80 can be used, including a lock, a clip, a latch, or the like. In the current arrangement, the retainer 80 is a latch, which is best shown in FIGS. 6B and 7B. The latch 80 is hingedly connected to the loop 60 at the outlet 64b of the channel 62. The latch 80 has a lever 82 and is movable between first and second positions. The latch 80 in the first or closed position shown in FIG. 7B retains the anchor lines (20) in the channel 62 by enclosing around the bunch of anchor lines (20) in the channel 62. Meanwhile, the latch 80 can be pivoted open to the second or opened position for receiving and releasing the anchor lines (20) from the channel 62. A spring 84 can bias the latch 80 to the closed position.

In use, the handling device 50 secures anchor rigs 10 and attached decoys 30 and keeps the anchor lines 20 organized so they will not tangle. The handling device 50 also allows for easy transportation for a set of the anchor rigs 10 and decoys 30. For example, the loop 60 of the handling device 50 may hold up to twelve anchor rigs 10 and attached decoys 30.

In the current configuration, the connector 70 includes the eyelet to which the carabiner 24 on the anchor lines 20 can connect. When handling the anchor lines 20 and connected decoys 30, the hunter can group together a set (e.g., twelve) anchor lines 20 of the anchor rigs 10 and can connect the carabiner 24 to their looped ends 22. The hunter then hooks the carabiner 24 to the eyelet 70 at the bottom of the tear drop shaped loop 60 and wraps a length of the anchor lines 20 in the loop's channel 62 around the outer edge 61 of the loop 60. At the outlet 64b of the channel 62 at the bottom of the tear drop shaped loop 60, the hunter opens the latch 80, fits the bundle of anchor lines 20 in place, and closes the latch 80 so the remaining length of the anchor lines 20 can extend from the loop 60. The hunter can then pass his/her arm through the interior space 63 of the loop 60 and support the loop 60 on his/her shoulder. The weighted ends 26 and decoys 30 connected to the anchor lines 20 can now be handled more easily and can be kept from becoming entangled with other sets of anchor lines 20.

FIG. 7C illustrates a detail of another connector 72 for the disclosed loop 60. Instead of an eyelet as used in the previous configuration, the connector 72 is a hook. When handling the anchor lines 20 and connected decoys 30, the hunter can group together a set (e.g., twelve) anchor lines 20. The looped ends 22 can be connected to the carabiner 24, which can then be hooked to the hook 72. Alternatively, the hunter can hook the looped ends 22 of the anchor lines 20 directly to the hook 72. Either way, the lengths of the anchor lines 20 are wrapped in the loop's channel 62, and the latch 80 at the end of the channel 62 is opened and closed to retain the anchor lines 20.

FIG. 7D illustrates a detail of yet another connector 74 for the disclosed loop 60. Instead of an eyelet or a hook as used in previous configurations, the connector 74 is a fixed shackle attached to the loop 60. When handling the anchor lines 20 and connected decoys 30, the hunter can group together a set (e.g., twelve) anchor lines 20. The looped ends 22 can be connected to a separate carabiner 24, which can then be hooked to the fixed shackle 74. Alternatively, the hunter can hook the looped ends 22 of the anchor lines 20 directly to fixed shackle 74. Either way, the lengths of the anchor lines 20 are wrapped in the loop's channel 62, and the latch 80 at the end of the channel 62 is opened and closed to retain the anchor lines 20.

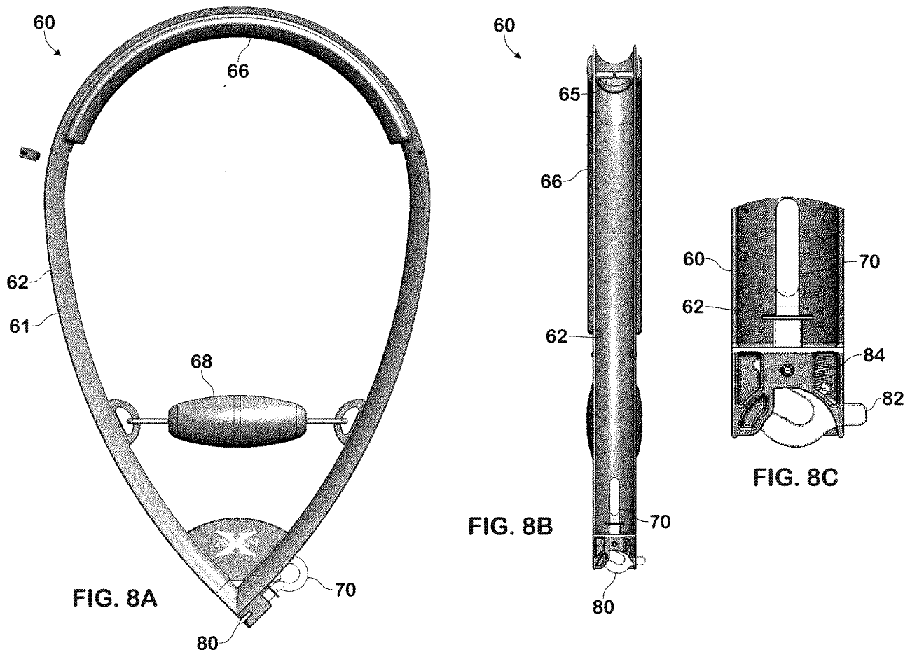

FIG. 8A illustrates yet another elevational view of the disclosed handling device 50, and FIG. 8B illustrates another side view of the disclosed handling device 50. Finally, FIG. 8C illustrates another detail of a connector 70 and a retainer 80 on the end of the disclosed handling device 50.

As disclosed herein, the handling device 50 includes a floating shoulder loop 60, which can organize and store components of anchor rig 10, such as a Texas Rig Anchor System, for decoys 30. The loop 60 has a tear drop shape, which allows the anchor rig 10 to be stored in an open face design. Once the anchor lines 20 are secured, the loop 60 keeps the anchor rigs 10 from tangling with other rigs and also allows for easy transportation.

The loop 60 can be injected molded from a high strength plastic and can have a molded shoulder padding 66, a flotation buoy 68, and clips 65. The connector 70, such as the eyelet, can be stainless steel for attaching to a D-ring or carabiner 24.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

1. A device useable by a person to handle decoys connectable to anchor rigs, the anchor rigs having anchor lines and fasteners, each of the anchor lines having a first end and a second end, the fasteners disposed on the anchor lines and being connectable to the decoys, the device comprising:
a loop having an outer edge and defining an interior space, the loop defining a channel about the outer edge, the channel being configured to hold a length of the anchor lines wound about the outer edge of the loop;
a connector disposed at a first portion of the channel and being configured to hold the first ends of the anchor lines to the loop; and
a retainer disposed at a second portion of the channel and being configured to releasably retain the anchor lines with the second ends passing from the channel.

2. The device of claim 1, wherein the interior space of the loop is configured to pass over an arm of the person; and wherein the loop is configured to position on a shoulder of the person.

3. The device of claim 1, further comprising a flotation buoy disposed on the loop.

4. The device of claim 1, wherein the retainer comprises:
a latch hingedly connected to the loop and being movable between a first position and a second position, the latch in the first position retaining the anchor lines in the channel, the latch in the second position releasing the anchor lines from the channel; and
a spring biasing the latch to the first position.

5. The device of claim 1, wherein the loop comprises a plurality of clips disposed in the channel, the clips being configured to flexibly receive and release the anchor lines.

6. The device of claim 1, wherein the loop has an inner edge disposed about the interior space; and wherein the loop comprises a padding disposed on a portion of the inner edge facing the interior space.

7. The device of claim 1, wherein the loop has a tear drop shape with a curved top and a pointed bottom, the first and second ends of the channel being disposed at the pointed bottom of the tear drop shape.

8. The device of claim 1, wherein the connector comprises an eyelet to which a carabiner disposed on the first ends is configured to releasably connect.

9. A device useable by a person to handle decoys connectable to an anchor system, the anchor system having anchor lines and fasteners, each of the anchor lines having a first end and a second end, the fasteners disposed on the anchor lines and being connectable to the decoys, the device comprising:
a loop having an outer edge and defining an interior space, the loop defining a channel about the outer edge, the channel being configured to hold a length of the anchor lines wound about the outer edge of the loop;
a connector disposed at a first portion of the channel and being configured to hold the first ends of the anchor lines to the loop; and
a retainer disposed at a second portion of the channel and being configured to releasably retain the anchor lines with the second ends passing from the channel.

10. The device of claim 9, wherein the interior space of the loop is configured to pass onto an arm of the person therethrough; and wherein the loop is configured to position on a shoulder of the person.

11. The device of claim 9, further comprising a flotation buoy disposed on the loop.

12. The device of claim 9, wherein the retainer comprises:
a latch hingedly connected to the loop and being movable between a first position and a second position, the latch in the first position retaining the anchor lines in the channel, the latch in the second position releasing the anchor lines from the channel; and
a spring biasing the latch to the first position.

13. The device of claim 9, wherein the loop comprises a plurality of clips disposed in the channel, the clips being configured to flexibly receive and release the anchor lines.

14. The device of claim 9, wherein the loop has an inner edge disposed about the interior space; and wherein the loop comprises a padding disposed on a portion of the inner edge facing the interior space.

15. The device of claim 9, wherein the connector comprises one of:
an eyelet being configured to connect to a carabiner on the first ends of the anchor lines;
a hook being configured to hook to the first ends of the anchor lines; and
a shackle being configured to releasably connect to the first ends of the anchor lines.

16. The device of claim 9, wherein the loop has a tear drop shape with a curved top and a pointed bottom, the first and second portions of the channel being disposed at the pointed bottom of the tear drop shape.

17. An assembly useable by a person to handle decoys, the assembly comprising:
an anchor system having anchor lines and fasteners, each of the anchor lines having a looped end and a weighted end, the fasteners slidably disposed on the anchor lines and being configured to connect to the decoys;
a loop having an outer edge and defining an interior space, the loop being configured to position on a shoulder of the person with an arm of the person extending through the interior space of the loop, the loop defining a channel about the outer edge, the channel being configured to hold a length of the anchor lines wound about the outer edge of the loop;
a connector disposed at a first portion of the channel and being configured to hold the looped ends of the anchor lines to the loop; and
a retainer disposed at a second portion of the channel and being configured to releasably retain the anchor lines with the weighted ends passing from the channel.

18. The assembly of claim 17, further comprising a flotation buoy disposed on the loop.

19. The assembly of claim 17, wherein the retainer comprises:
a latch hingedly connected to the loop and being movable between a first position and a second position, the latch in the first position retaining the anchor lines in the channel, the latch in the second position releasing the anchor lines from the channel; and
a spring biasing the latch to the first position.

20. The assembly of claim 17, wherein the loop comprises a plurality of clips disposed in the channel, the clips being configured to flexibly receive and release the anchor lines.

21-24. (canceled)
